(19) United States
(12) Patent Application Publication
(10) Pub. No.: US 2017/0011324 A1
(43) Pub. Date: Jan. 12, 2017

(54) DISPATCH SYSTEM FOR MATCHING DRIVERS AND USERS

(71) Applicant: Uber Technologies, Inc., San Francisco, CA (US)

(72) Inventors: Michael Truong, San Francisco, CA (US); David Purdy, Millbrae, CA (US); Rami Mawas, Dublin, CA (US)

(21) Appl. No.: 14/793,593

(22) Filed: Jul. 7, 2015

(51) Int. Cl. G06Q 10/06; G06Q 50/32

(52) U.S. Cl. CPC G06Q 10/063112; G06Q 50/32

(57) ABSTRACT

A dispatch system in connection with a transport service is provided. The dispatch system receives pick-up requests from requesting users and identifies a plurality of proximate drivers in relation to each of the requesting users. For each requesting user, the dispatch system runs a matching operation, using a plurality of relevant factors, to select an optimal driver from the plurality of proximate drivers to service the pick-up request.

### BACKGROUND

With the advent of application-based, on-demand transportation services, the connectivity between riders and drivers is vastly expanding. Some current dispatch systems for arranging transportation services can assign drivers to provide services based solely on physical or temporal proximity to riders.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram illustrating an example dispatch system for matching drivers with requesting users;

FIG. 2 is a block diagram illustrating an example matching engine implemented in connection with a dispatch system;

FIG. 3A is a high level flow chart illustrating an example method for matching optimal drivers with requesting users;

FIG. 3B is a low level flow chart illustrating an example method for matching optimal drivers with requesting users;

FIGS. 4A and 4B are example screenshots illustrating a user request and match confirmation on a user device;

FIG. 5 is a block diagram illustrating a computer system upon which examples described herein may be implemented; and

FIG. 6 is a block diagram illustrating a mobile computing device upon which examples described herein may be implemented.

### DETAILED DESCRIPTION

In some examples described herein, a dispatch system is provided in connection with a network service that can match drivers with requesting users based on a number of optimization factors. In accordance with examples described herein, the dispatch system can receive pick-up requests from requesting users. Based on the location of a requesting user or a specified pick-up location, the dispatch system can identify a plurality of proximate drivers in relation to the requesting user or the specified pick-up location. Using one or more optimization factors, the dispatch system can perform a matching operation to select an optimal driver from the plurality of proximate drivers to service the pick-up request. The optimization factors can include user preferences, driver ratings history, reputation data, complaint history, punctuality history, etc. The optimal driver may be selected based on meeting or exceeding a certain threshold (e.g., a probability that the requesting user will give the driver a 5-star rating). Additionally or alternatively, the optimal driver may be selected based on attaining a highest score, in relation to the other proximate drivers, based on the results of the matching operation.

In various implementations, the dispatch system can store driver profiles which can include historical driver data (e.g., driver ratings for individual trips and/or overall driver ratings), and user profiles which can include, for example, the user's rating information and/or user-specified preferences. Accordingly, the dispatch system can initially identify a user requesting a transport service. The dispatch system can further identify a plurality of available proximate drivers to the requesting user or the pick-up location of the transport service. The dispatch system may then perform a lookup for relevant historical data of both the requesting user and the proximate drivers to perform the matching operation in order to select the most optimal driver to service the pick-up request.

In many examples, the matching operation may involve using or analyzing various features of the pick-up request, the requesting user's profile, the proximate drivers' profiles, and/or third party and/or environmental data. As an example, a pick-up request may include a pick-up location, a destination location, and/or a vehicle type information, which may be utilized as an optimization factor in the matching operation in order to select the most optimal driver from the proximate drivers. The dispatch system can utilize the destination location, for example, to determine whether any of the proximate drivers have provided transport services to the destination location and to identify the ratings or scores (e.g., a star rating) that that driver has received from respective riders. In some examples, such ratings can be referred to as destination-specific driver ratings that match a given destination. The destination-specific driver ratings may be weighted, along with various other optimization factors (e.g., the user's preferred vehicle type, driver reputation and/or complaint history, a history between the requesting user and a driver, etc.), to select the most optimal driver. The dispatch system can select a highest scored driver from the proximate drivers based on the matching operation. Alternatively, the dispatch system may set a user-specific match threshold which must be exceeded by a driver in order for the driver to be selected.

Among other benefits, the examples described herein achieve a technical effect of improving user experience in connection with transportation services. Current user/driver pairings can be made based solely on proximity, without further enquiry into the individual preferences of the user. In examples described herein, however, the dispatch system can extrapolate or determine an individual rider's preferences based on historical data, such as based on the user ratings that that rider gave to drivers that provided previous transport services, and use the determined preferences to select a driver for that rider. Accordingly, examples described herein enable a smart dispatch system, that utilizes gathered historical data, to optimally match drivers and riders (e.g., users) in real-time. Thus, with continued learning and data gathering, example dispatch systems described herein can continue to increase the quality of user (and driver) experience.

As used herein, a computing device refer to devices corresponding to desktop computers, cellular devices or smartphones, personal digital assistants (PDAs), laptop computers, tablet devices, television (IP Television), etc., that can provide network connectivity and processing resources for communicating with the system over a network. A computing device can also correspond to custom hardware, in-vehicle devices, or on-board computers, etc. The computing device can also operate a designated application configured to communicate with the on-demand delivery system.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples disclosed herein can be carried and/or executed. In particular, the numerous machines shown with examples of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

System Description

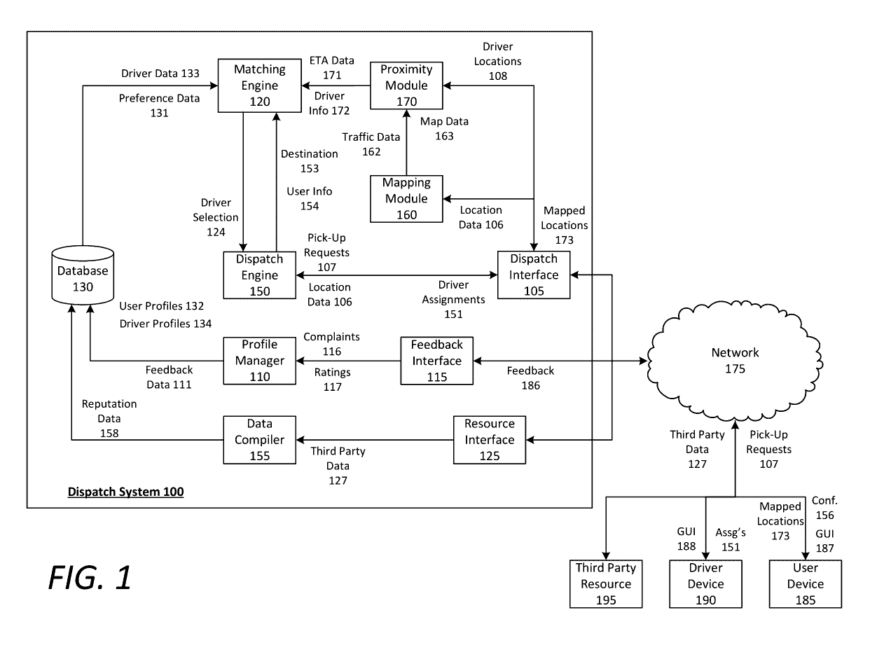

FIG. 1 is a block diagram illustrating an example dispatch system for matching drivers with requesting users. A dispatch system 100 can include a database 130 storing user profiles 132 (or rider profiles) and driver profiles 134 for users/riders and drivers/service providers of a network service, respectively. As described herein, the dispatch system 100 (and/or the client applications operating on user devices and driver devices) can provide a network service or platform in which riders and drivers can be matched for receiving and providing transport services. For example, the network service can be accessible on user devices 185 and driver devices 190 via execution of a designated client application, which can generate a graphical user interface (GUI) 187 specific to the user device 185, or a GUI 188 specific to the driver device 190 (e.g., a rider application or a driver application, respectively). When a driver is selected to service a particular pick-up request, the dispatch system 100 can generate and transmit an invitation to selected driver's computing device (running the driver application) to service the pick-up request.

Over time, as users and drivers receive and provide transport services, respectively, historical data about such completed transport services can be gathered/stored indicating relevant information concerning respective users and drivers. For example, when a given transport service (e.g., also referred to herein as a trip) is completed, the rider application can provide a GUI 187 that enables the user or rider of that trip to provide feedback for the driver. The user can provide input via the user device 185 to submit feedback information to the network service. In one example, the dispatch system 100 can include a feedback interface 115 to receive feedback information (e.g., feedback 186) from rider applications that indicate the respective user's overall experience for any given completed trip. This feedback 186 can include a driver rating 117 for the driver of the trip (e.g., a star rating), and/or a complaint 116 against the driver for some form of infraction (e.g., rude behavior, disregard for traffic laws, the vehicle state, etc.). In some examples, the complaint 116 can be in the form of a textual message that is inputted by the user. As an addition or an alternative, the feedback 186 can include textual content or comments that may indicate positive feedback, e.g., something that the user was happy about with the driver or the trip.

A profile manager 110 of the dispatch system 100 can use such complaint data 116 and ratings data 117 (collectively “feedback data 111”) to manage the various user profiles 132 and driver profiles 134 stored in the database 130. For example, for each completed trip, the profile manager 110 can (i) associate the feedback data 111 to both a user profile 132 of the user that provided the feedback and/or a driver profile 134 of the driver that provided the trip for the user, and/or (ii) associate the feedback data 111 to a record associated with the completed trip (e.g., a trip record) stored in the database 130. The profile manager 110 can also extrapolate or determine, for individual users, preference information using collected feedback data 111. As described herein, a trip record can include information associated with the transport service, such as the user information or identifier (ID), the driver information or ID, a start time and start location of the trip, an end time and end location of the trip, a vehicle type taken by the user, the route traveled, the price or fare for the trip, the feedback data of the driver (given by the user), the feedback data of the user (given by the driver), etc. In this manner, for a given user, the dispatch system 100 can store historical data about trips that the user has taken as well as the driver ratings (e.g., two stars out of five stars, or five stars out of five stars, etc.) that that user gave to the individual drivers that provided those trips.

In one example, the feedback data 111 can link a sentiment between the user and the driver, which can further be linked to various conditions that existed or occurred with the trip, including, for example, the vehicle manufacturer or type, a class of the user (e.g., if the user is an employee of the entity that operates the dispatch system 100), the price or price rate of the trip, the time and/or the day of the week, the end location or destination of the trip, etc. The dispatch system 100 can extrapolate or determine an individual user's preferences based on what trip conditions existed or occurred that resulted in that user being satisfied or extremely satisfied with a trip or a driver of the trip, such that the user gave high ratings (e.g., four or five stars out of five) to that driver, or being dissatisfied or extremely dissatisfied with a trip or a driver of the trip, such that the user gave low ratings (e.g., zero to three stars) to that driver. Furthermore, the content of the feedback data 111 can provide further information regarding the user's preferences when receiving a transport service. The profile manager 110 can parse through or analyze the content of the feedback data 111 submitted by a given user for a driver to determine the user preferences. Additionally or alternatively, the designated application can include a feature that enables the given user to set various preferences.

In some examples, the user profile 132 can include a blacklist feature where the user is enabled to blacklist certain drivers to avoid future pairings. For matching operations, the matching engine 120 may identify whether one or more proximate drivers, in relation to the requesting user, are included in the user's blacklist. If so, the dispatch system 100 may automatically disregard the blacklisted driver(s) from the matching operation. Additionally or alternatively, the user preferences can be incorporated into the given user's profile 132, and can include an assortment of factors, such as a preferred vehicle type (e.g., luxury cars, SUVs, a preferred brand of vehicle, hybrid electric cars, driverless vehicles, and the like). Other factors may be concealed in the feedback data 111 such as a preference towards punctuality, a preference (or lack thereof) towards newer vehicles, an age range preference for the driver, and the like. The profile manager 110 can identify and flag such preferences in the given user's profile 132. Additionally or alternatively, each user profile 132 can include various user information, such as age, height, weight, gender, eye color, hair color, background, home address, work address, citizenship, country of origin, and various other user data, preferences, or configurations.

Furthermore, such feedback data 111 can enable the profile manager 110 to compile a given driver's profile 134 based on overall performance and merit. The driver profile 134 can include an overall rating for the driver (e.g., 4.67 stars), as well as individual ratings and/or complaints given by users. Each individual rating may be driver and/or destination specific. Accordingly, the profile manager 110 can identify various performance traits of the given driver. For example, the feedback data 111 may indicate that the given driver excels on certain types of trips (e.g., trips to the airport, trips in dense urban centers, etc.), while lagging behind in performance on other types of trips (e.g., long distance trips, trips on mountainous roads, etc.). For instance, a given driver may have received an average rating of 4.95 stars when that driver provides transport from San Francisco to San Francisco International Airport (e.g., from data analyzed from one hundred such trips the driver completed), but may have received an average rating of 4.23 stars when that driver provides within the San Francisco city limits for trips lasting longer than 15 minutes (e.g., from data analyzed from two hundred such trips the driver completed). Based on the feedback data 111, the profile manager 110 can determine that the given driver excels on certain types of trips and lags behind on other types of trips.

As other examples, the feedback data 111 may indicate whether the given driver maintains a relatively well-ordered vehicle interior, whether the given driver maintains the condition of the vehicle, whether the driver is punctual, etc. All such factors may be compared against the user's preferences when the dispatch system 100 performs a matching operation. Additionally or alternatively, each of the driver profiles 134 can also include driver information, such as age, height, weight, gender, eye color, hair color, background, vehicle type, home address, citizenship, country of origin, and various driver preferences.

In certain implementations, the dispatch system 100 can further include a data compiler 155, which can pull third-party data 127 from one or more third party resources 195 over the network 175. For example, the data compiler 155 can pull reputation data 158, via a resource interface 125, for a particular driver. The reputation data 158 can indicate background information of the particular driver relating to, for example, public service, studiousness, work ethic, former military service, former law enforcement service, family background information, and the like. However, the reputation data 158 can also indicate concerning information such as a criminal history, a violent background, an affiliation with a criminal or scandalous group, delinquent financial behavior, or a propensity towards harassment, drugs or alcohol, other irresponsible behavior, etc. Such reputation data 158 may be incorporated into the given driver's profile 134 for use during a matching operation by the dispatch system 100.

The dispatch system 100 can include a dispatch engine 150, which can provide driver assignments 151 to service individual pick-up requests 107 based on a variety of factors. The dispatch system 100 may include a dispatch interface 105 for communication with user devices 185 and driver devices 190. A user that wishes to submit a pick-up request 107 can launch the designated application on the user's device 185 (e.g., a smartphone, a tablet computer, a wearable computing device, a personal computer, etc.), which can generate a GUI 187 specific to the transport service. Using the GUI 187, the user can send a pick-up request 107 indicating a pick-up location and/or a destination (as well as a vehicle type). The pick-up location can correspond to a current location of the user device 185 (by using geo-aware or location-based resources of the user device 185) or a specified location inputted by the user. The dispatch interface 105 can provide the pick-up request 107 to the dispatch engine 150, which can submit the requesting user's information 154 (e.g., the user's name, a unique identifier, or some other identifying criteria of the user) to a matching engine 120 of the dispatch system 100.

Upon receiving the pick-up request 107, the dispatch engine 150 may also receive location data 106 of the requesting user. The location data 106 may be received via location-based resources of the user device 185, or may be received as a part of the pick-up request 107. The location data 106 may further be transferred to a mapping module 160 of the dispatch system 100. Upon launching the designated application, or upon receiving the pick-up request 107, a proximity module 170 of the dispatch system 100 can identify the driver locations 108 of all available (or unavailable) proximate drivers in relation to the requesting user. In one example, a driver tracking component (e.g., not shown in FIG. 1 for purpose of simplicity) can periodically receive location information (e.g., the driver locations 108) corresponding to the current location of the driver from the driver devices 190 and provide the location information to the proximity module 170 and/or can store the location information in a database that is accessible by the proximity module 170. The mapping module 160 can provide the location of the requesting user and provide map data 163 of a geographic region that includes or corresponds to the pick-up location to the proximity module 170. Additionally, the mapping module 160 may further provide traffic data 162 to the proximity module 170 identifying traffic conditions near the requesting user. While the mapping module 160 of FIG. 1 is shown as a component of the dispatch system 100, other arrangements are contemplated in which the mapping data 163 and traffic data 162 are provided by an external mapping resource over the network 175.

As an addition or alternative, the proximity module 170 can utilize the map data 163, including the pick-up location, and the driver locations 108 to identify the proximate drivers in relation to the requesting user (or the user's specified pick-up location). In some implementations, the proximity module 170 can provide the mapped locations 173 to the user's device 185—where the mapped locations 173 can include a map comprising the real-time relative locations of proximate drivers in relation to the user's current location, or in relation to a pinned pick-up location configured by the requesting user on the GUI 187.

The proximity module 170 can determine which drivers are within a predetermined distance of the pick-up location (e.g., within four miles) and/or are within an estimated time of travel from the pick-up location (e.g., within six minutes). For example, the proximity module 170 can utilize the driver locations 108, the map data 163, and/or the traffic data 162 to determine an estimated time of arrival (ETA) 171 for each of the proximate drivers to the user's location. As described below, the ETA data 171 for each proximate driver can be utilized by the matching engine 120 as one of a number of optimization factors to ultimately select an optimal driver to service the pick-up request 107.

As provided herein, the matching engine 120 can receive the user information 154 of the requesting user from the dispatch engine 150. The matching engine 120 can further receive driver information 172 for the proximate drivers identified by the proximity module 170. According to examples described herein, the matching engine 120 can utilize the user information 154 from the pick-up request 107 and the driver information 172 to perform a lookup of the driver profiles 134 of the proximate drivers and the user profile 132 of the requesting user. Based on the information in the driver profiles 134 and the user profile 132, the matching engine can make a driver selection 124, from the proximate drivers, to service the received pick-up request 107. Additionally, the matching engine 120 can utilize further information, external to the information provided in the user profile 132 and driver profiles 134. For example, the matching engine 120 can utilize the ETA data 171 generated by the proximity module 170. Additionally or alternatively, the matching engine 120 can utilize the destination 153 indicated by the user. Further information, such as environmental factors, pricing conditions, traffic conditions, etc., may also be considered by the matching engine 120.

In various examples, the matching engine 120 can make comparisons between the driver data 133 in the driver profiles 134 of the proximate drivers, and the preference data 131 indicated in the user profile 132 of the requesting user. As discussed above, this driver data 133 can include driver traits (e.g., driver behaviors, tendencies) and ratings from the feedback data 111 compiled by the profile manager 110 and/or reputation data 158 gathered by the data compiler 155. Additionally, the driver data 133 can include invariable data including, for example, the driver's age, gender, vehicle type, and the like. Further, the preference data 131 may include preferences directly configured by the requesting user, or preferences determined by the profile manager 110 based on the requesting user's rating history.

The preference data 131 may indicate that the requesting user favors certain factors over other factors. Thus, certain factors may be weighted more heavily than other factors. For example, the preference data 131 may indicate that the requesting user has no preference for the type of car, but a strong preference for drivers that have a high overall rating. The matching engine 120 may weigh the factors accordingly. Furthermore, certain factors may be relevant while others may be irrelevant to a driver selection 124 by the matching engine 120.

For example, for illustrative purposes, for a given user, the profile manager 110 can extrapolate or determine (e.g., from two hundred driver ratings given by that user for previously completed trips) the preference data 131 for that user. The profile manager 110 can determine that when the user is assigned a vehicle that is a larger vehicle type (e.g., an SUV as compared to a sedan or a hybrid sedan), the user has given 95% of those drivers a maximum satisfaction score (e.g., five stars out of five stars), and when the user is assigned a vehicle that is a sedan, the user has given 70% of those drivers a maximum satisfaction score. In another example, the profile manager 110 can determine that when ten out of twelve textual feedback given by that user corresponds to a complaint about the cleanliness of the vehicle, and that such drivers received a low score (e.g., two stars or less out of five stars). Still further, in another example, the profile manager 110 can extrapolate that when the price is high (e.g., a price multiplier of 1.5 times the default price at the time the request was made) the user has given only 25% of those drivers a maximum satisfaction score and that 50% of those drivers received a medium score (e.g., three stars out of give stars). Such extrapolated preference data 111 can indicate to the dispatch system 100 that during such high pricing conditions, the user is most likely going to give a medium to low rating for drivers unless the user receives a driver/vehicle or trip that meets or exceeds the user's expectations.

The weighted relevant factors from the preference data 131 may be compared to the driver data 133 for the proximate drivers, the ETA data 171, and/or the destination 153 indicated by the user. Collectively, these optimization factors can be utilized by the matching engine 120 to run a matching operation in order to make the most optimal driver selection 124 from the proximate drivers. For example, the matching engine 120 can compute an optimization score, based on the factors, for each of the proximate drivers. The optimization score can correspond to a probability that the requesting user will provide the respective proximate driver with a maximum satisfaction rating (e.g., five stars out of five stars). The driver selection 124 may be based on a highest probability that the selected driver will receive a 5-star rating from the requesting user. Similarly, the driver selection 124 may be based on an overall score calculated by the matching engine 120 based on the results of the matching operation.

As an addition or an alternative, the matching engine 120 may set a threshold value (e.g., an 82% probability that the driver will receive a 5-star rating). Based on a matching operation, the matching engine 120 may determine that none of the proximate drivers exceed the threshold value. In such scenarios, the matching engine 120 may select the driver having a score closest to the threshold value. Alternatively, the matching engine 120 can request that the proximity module 170 expand the pool of proximate drivers until the matching engine identifies a driver exceeding the threshold value. According to such examples, the matching engine 120 can dynamically run matching operations to dynamically determine whether any driver from a current pool of proximate drivers exceeds the threshold value. Thus, the driver selection 124 may be made based on the results of such dynamic operations.

In accordance with examples described herein, the dispatch engine 150 can receive a pick-up request 107 from a respective user device 185 and transmit identifying user info 154 and the selected destination 153 to the matching engine 120. Furthermore, the proximity module 170 can identify proximate drivers in relation to the requesting user and calculate or estimate an ETA 171 for each of the proximate drivers. The matching engine 120 can utilize identification information for both the requesting user and the proximate drivers to pull the requesting user's profile 132 and the proximate drivers' profiles 134 to perform a matching operation. Utilizing the preference data 131 from the user profile 132, the matching engine 120 can identify and attribute weightings to relevant factors for the matching operation. Such relevant factors may include various user preferences which can be assessed against the driver data 133, the ETA data 171, the destination 153 (e.g., whether a particular driver has higher ratings for the destination 153), etc. Using such relevant optimization factors, the matching engine can perform the matching operation to identify and make a driver selection 124 of an optimal driver from the proximate drivers. The matching engine 120 can submit this driver selection 124 to the dispatch engine 150, which can transmit a driver assignment 151 or invitation to the selected optimal driver based on the matching operation. Once the selected driver accepts the assignment 151, e.g., by providing input on the driver application, the dispatch engine 150 can submit a confirmation 156 to the requesting user's device 185 indicating that the optimal driver has been selected for the user and is en route to service the user.

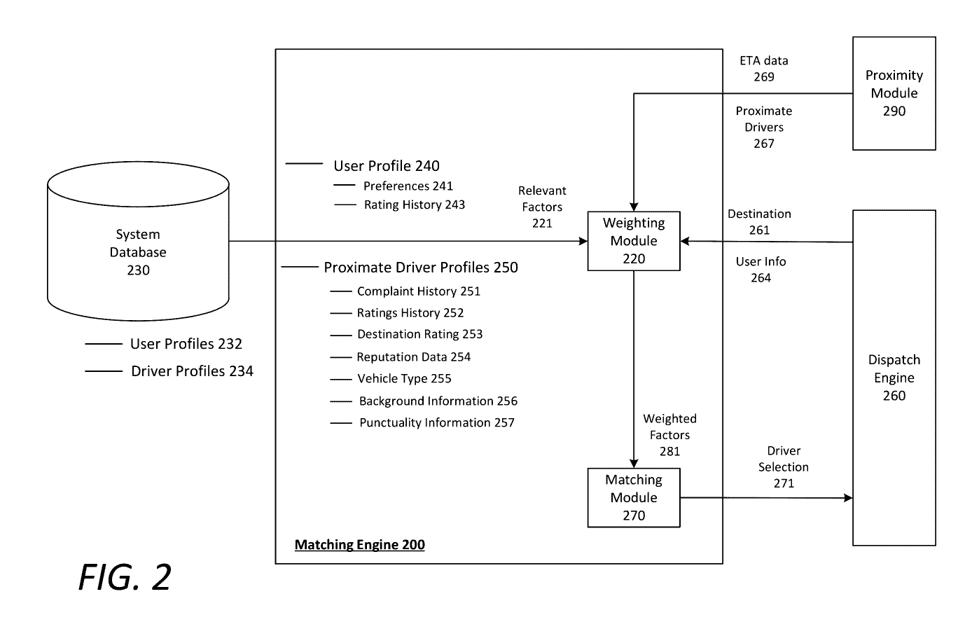

FIG. 2 is a block diagram illustrating an example matching engine implemented in connection with a dispatch system—for example, the dispatch system 100 as illustrated in FIG. 1. The matching engine 200 can be in communication with a dispatch engine 260, a proximity module 290, and a system database 230—which includes user profiles 232 and driver profiles 234 for users and drivers of the transport service. Some or all of these components may be included in the dispatch system 100, as provided in connection with FIG. 1. Referring to FIG. 2, the matching engine 200 can include a weighting module 220 which can receive information from the dispatch engine 260 when a pick-up request is received. Such information can include data embedded in the pick-up request itself, such as user information 264 that identifies the requesting user (e.g., a unique identifier of the user's mobile device). The information received by the weighting module 220 from the dispatch engine 260 can also include a destination 261 associated with the pick-up request.

In some examples, the weighting module 220 can receive proximate driver information 267 from the proximity module 290. The proximate driver information 267 can identify drivers proximate to a current location of the requesting user. Additionally, the weighting module 220 can receive ETA data 269 from the proximity module 290 corresponding to an estimated time each proximate driver would take to rendezvous with the requesting user.

Using the user information 264 and the proximate driver information 267, the weighting module 220 can pull the requesting user's profile 240 and the proximate drivers' profiles 250 from the system database 230. As discussed above, the user profile 240 can comprise information indicative of the requesting user's preferences 241, which can be determined and/or identified by the weighting module 220. These determined preferences 241 can include an assortment of factors, such as a preferred vehicle type (e.g., luxury cars, SUVs, a preferred brand of vehicle, hybrid electric cars, driverless vehicles, and the like). Other factors may include factors hidden in the ratings history 243 of the requesting user, such as a preference towards punctuality, a preference towards newer vehicles or vehicle types, an age range preference for the driver, and the like. The ratings history 243 may further include individual user ratings for any number of drivers. Furthermore, each of the individual user ratings can be specific to a particular destination. The weighting module 220 can compare these user preferences 241 indicated in the various data from the user profile 240 against data compiled in the proximate driver profiles 250 to identify a number of relevant factors 221 to be weighted for optimization in a matching operation.

According to certain implementations, the weighting module 220 can identify the relevant factors 221 from the proximate driver profiles 250 based on the determined preferences 241 of the requesting user. Such relevant factors 221 may include, for each of the proximate drivers, a complaint history 251, a ratings history 252, a destination rating 253 associated with the destination 261, information comprised in the reputation data 254 (e.g., third party reputation information), the proximate driver's vehicle type 255, background data 256, punctuality information 257 (e.g., an overall punctuality score), and the like. As provided in some implementations, the ratings history 252 of a proximate driver may include any number of individual ratings from users, and each may be specific to a particular destination. When an individual rating matches the destination 261 input by the requesting user, the weighting module 220 can identify the rating as a destination-specific rating 253 tied to the destination 261 of the requesting user. Accordingly, the matching engine 200 can identify a proximate driver having a highest destination specific rating that matches the destination specified in the pick-up request. Various other features are contemplated for matching a driver with a user. Furthermore, the weighting module 220 can disregard or apply lighter weightings to irrelevant features in light of the user preferences 241.

From the user profile 240 and the proximate driver profiles 250, the weighting module 220 can compile relevant factors 221 and apply a weighting to each factor. Furthermore, the weighting module 220 can account for the ETA data 269—in which closer proximate drivers may be weighted more favorably or heavily than more distant drivers. As an example, the determined user preferences 241 may indicate a strong preference for a certain vehicle type (e.g., electric vehicles). The weighting module 220 can identify the vehicle type 255 of the proximate drivers as a relevant factor 221 and apply a greater weighting to the vehicle type 255 as opposed to say, punctuality. Similarly, the rating history 243 of the requesting user may indicate a strong preference for drivers that have an impeccable record (e.g., drivers that have a high overall rating). Accordingly, the weighting module 220 can identify the ratings history 252 of the proximate drivers as a relevant factors 221 and apply a heavier weighting accordingly.

Along these lines, the weighting module 220 can identify that certain factors are unimportant to the requesting user. For example, the weighting module 220 may identify from the rating history 243 that the requesting user applies high ratings to drivers irrespective of the drivers' complaint history 251. Accordingly, the weighting module 220 can apply a lower (or lighter) weighting to complaint history 251 or disregard it altogether. Still further, the weighting module 220 can utilize the destination 261 to determine whether the ratings history 252 of any of the proximate drivers includes one or more ratings for the same destination. For example, the ratings history 252 may indicate that a given driver excels on certain types of trips (e.g., trips to the airport, trips in dense urban centers, etc.), while lagging behind in performance on other types of trips (e.g., long distance trips, trips on mountainous roads, etc.). As another example, the pick-up request may indicate the destination 261 as Prospect Park in Brooklyn. One of the proximate drivers may have grown up in Brooklyn and knows every secret back road and traffic trick to get passengers to Prospect Park quickly and safely. The ratings history 252 of this local driver may indicate an exceptionally high rating (e.g., nearly a 5-star rating) for drop-offs at Prospect Park. This destination rating 253 may be identified by the weighting module 220 and weighted heavily in favor of the local driver. Thus, the weighting module 220 may make a cross-comparison of the destination 261 indicated in the pick-up request, and destination-specific ratings 253 (e.g., ratings that match the destination 261 in the driver profiles 250), favoring or rejecting proximate drivers with higher or lower destination-specific ratings 253 respectively.

As provided herein, any number of factors may be processed and weighted by the weighting module 220, including a variety of factors not shown in FIG. 2. The weighting module 220 can parse through such factors to identify and apply weightings to only such relevant factors 221 identified, or can apply weightings to all factors. Some or all of the weighted factors 281 may be specific to certain drivers (e.g., drivers having a preferred vehicle type) in the ensuing matching operation, and/or may be applied evenly for all drivers in light of the user preferences 241 (e.g., inapplicable factors). Accordingly, these weighted factors 281 may then be submitted to a matching module 270 of the matching engine 200.

In various implementations, the matching module 270 can perform a matching operation using the weighted factors 281 for each proximate driver to determine an optimal driver to service the pick-up request. The weighting module 281 matching operation can comprise an optimization technique (e.g., an executing algorithm) in which each of the weighted factors 281 are applied per driver to identify, and ultimately select, a most optimal driver to service the pick-up request. The matching module 270 may set a predetermined threshold that a driver must meet before being selected (e.g., a 70% probability that the driver will received a 5-star rating), and/or the matching module 270 may automatically select the proximate driver attaining a highest optimization score. In certain implementations, the highest optimization score can correspond to a highest probability the selected proximate driver will received a 5-star rating from the requesting user.

Accordingly, based on the weightings for each of the weighted factors 281, the matching operation performed by the matching module 270 can result in a calculated optimization score for each of the proximate drivers. In some examples, the optimization scores for the drivers may be submitted to the requesting user for reference or selection. For example, the dispatch system can generate an optimization score for each driver on the GUI of the user's device, which may be displayed to the user. The optimization scores can be associated with driver indicators on a map of the user device in real-time. In other examples, the matching module 270 may perform a driver selection 271 of a most optimal one of the proximate drivers, and submit the driver selection 271 to the dispatch engine 260—which can then assign the optimal driver to service the pick-up request.

As a similar implementation, the matching engine 200 and proximity module 290 may perform operations dynamically, based on receiving a pick-up request, or in response to detecting a user launching the designated application specific to the transport service. In such examples, the proximity module 290 may apply a geo-fence surrounding the user's location (or a pinned pick-up location), where available drivers within the geo-fence may be considered as proximate drivers to the user. Proximate driver information 267 and ETA data 269 may be streamed to the weighting module 220, which can dynamically determine relevant factors 221 in light of the user and the proximate drivers, and submit such weighted factors 281 to the matching module 270.

In real-time, the matching engine 200 can dynamically calculate an optimization score for such proximate drivers as they enter the geo-fence. Drivers exiting the geo-fence may be disregarded, or their scores may be buffered for consideration in ultimately making a driver selection 271. Thus, upon launch of the designated application, the matching engine 200 can calculate optimization scores for all proximate drivers in relation to the user's current location. Furthermore, upon receiving a pick-up request and a destination, the matching engine 200 may automatically select the proximate driver with the highest optimization score, or update the optimization score in light of the destination. Accordingly, the dispatch engine 260 can utilize the driver selection 271 to assign the selected driver to service the pick-up request.

Methodology

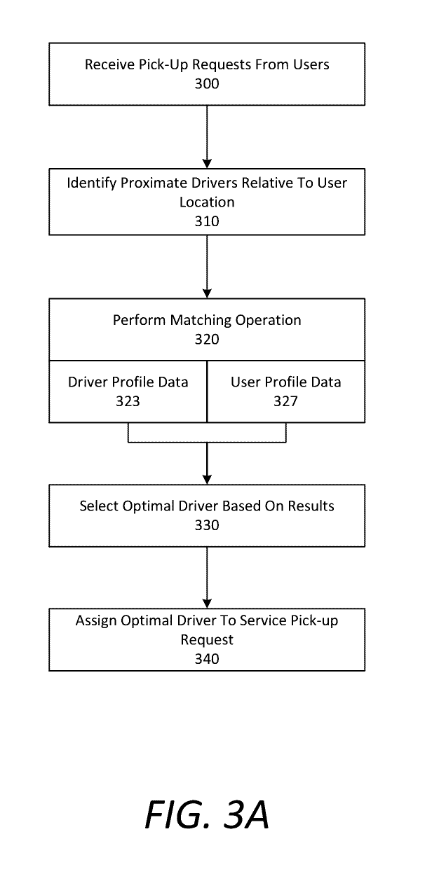

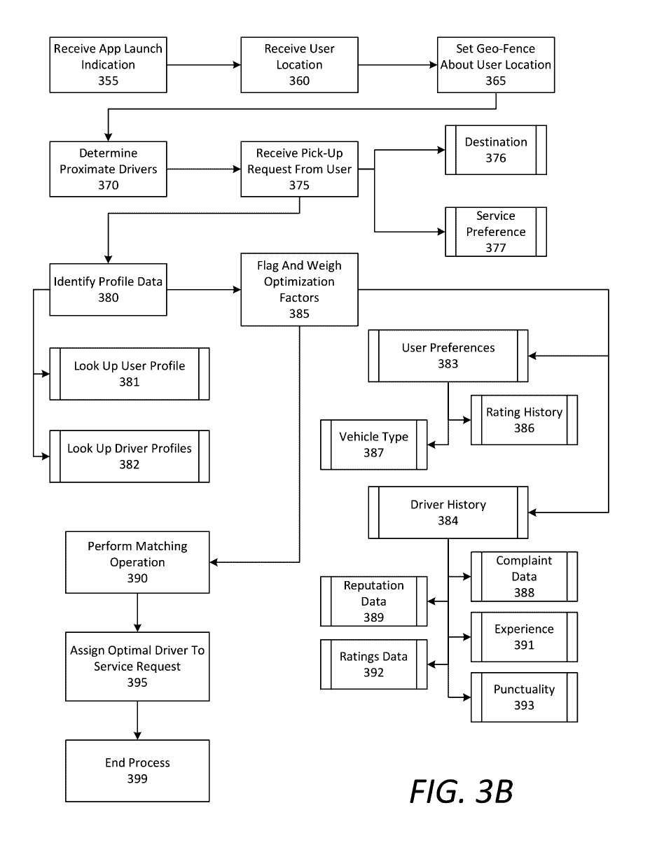

FIG. 3A is a high level flow chart illustrating an example method for matching optimal drivers with requesting users. In the below description of FIG. 3A, reference may be made to like reference characters representing various features of FIG. 1 for illustrative purposes. Furthermore, the high level method described in connection with FIG. 3A may be performed by an example dispatch system 100, as illustrated in FIG. 1. Referring to FIG. 3A, the dispatch system 100 can receive pick-up requests 107 from users of the transport service (300). The pick-up requests 107 may be received via user interactions with a GUI 187 generated on user devices 185, where the GUI 187 is specific to a designated application of the transport service. In response to the pick-up request, or in response to detecting a launch of the designated application on a particular user device, the dispatch system 100 can identify proximate drivers in relation to the current location of the user (310).

The dispatch system can utilize driver profile data (323) of the proximate drivers, and user profile data (327) of the requesting user to perform a matching operation to identify a most optimal one of the proximate drivers to service the pick-up request (320). As an example, the dispatch system 100 can compute an optimization score for each of the proximate drivers based on a variety of weighted optimization factors (e.g., user preferences determined by analyzing stored historical data for the user, and various factors provided in the driver history data for each of the proximate drivers). Accordingly, the dispatch system 100 may select the most optimal driver based on the results of the matching operation (330), and thereafter, assign the optimal driver to service the pick-up request (340).

FIG. 3B is a low level flow chart illustrating an example method for matching optimal drivers with requesting users. Likewise in FIG. 3A, in the below description of FIG. 3B, reference may be made to like reference characters representing various features of FIG. 1 for illustrative purposes. Referring to FIG. 3B, the dispatch system 100 can initially receive an indication that a user has launched the designated application specific to the transport service (355). This launch indication may trigger the dispatch system 100 to perform a number of operations. In some examples, the launch indication can trigger the user device 185 to initiate location-based resources (e.g., GPS resources). Accordingly, the dispatch system 100 can receive the current location of the user (360). Furthermore, the launch indication may cause the dispatch system 100 to set a geo-fence around the user's location (365) and trigger the dispatch system 100 to determine available drivers that are proximate to the user's location (370). The geo-fence may be set temporally (e.g., based on an ETA), or physically based on distance.

The dispatch system 100 can receive a pick-up request 107 from a particular user (375). In some examples, the pick-up request 107 can include a service preference (377), such as whether the user would like to request a black car, a luxury car, an SUV, a van, an electric car, a driverless car, etc. Additionally or alternatively, the pick-up request can specify a destination (376). Based on the pick-up request 107 and the proximate driver information, the dispatch system 100 can identify profile data for the requesting user and each of the proximate drivers (380). For example, the dispatch system 100 can look up the requesting user's profile in a database 130 of the dispatch system 100 (381). Furthermore, the dispatch system can look up each of the proximate drivers' profiles (382).

Using information provided in the requesting user's profile (e.g., user preference data (383) indicated in the user's profile by way of analysis of historical user data), the proximate drivers' profiles (e.g., rating history, complaint history, vehicle information, punctuality information, etc.), and the pick-up request (e.g., the destination), the dispatch system 100 can flag and weigh relevant optimization factors for each of the proximate drivers (385). For example, the dispatch system 100 can determine a number of user preferences (383) indicated in the user profile, or identified based on the user's rating history (386). The dispatch system 100 can further determine various other preferences, such as a preferred vehicle type (387) (determined via the user's rating history and/or direct input by the user).

The dispatch system 100 may compare such preferences against driver history information (384) for each of the proximate drivers, such as complaint data (388), reputation data (389), the driver's experience (391), ratings data (392), and driver punctuality (393). In various examples, the dispatch system 100 can further compare the determined user preferences (383) against other information specific to each driver, such as the driver's vehicle type and background information, etc., as discussed above with respect to FIG. 1.

In some implementations, the dispatch system 100 can weigh all optimization factors against the determined user preferences. In variations, the dispatch system 100 can disregard certain inapplicable factors for one or more of the proximate drivers. The dispatch system 100 can weigh each factor based on a strength or an importance of a corresponding user preference. For example, if the user preferences determined from the historical user data indicate a strong preference towards energy efficient cars, the dispatch system 100 can apply a heavier weighting vehicle type for proximate drivers having efficient cars. Accordingly, the dispatch system 100 can perform a matching operation based on all weighted factors (applicable or both applicable and inapplicable) for each of the proximate drivers (390). In certain examples, the matching operation itself may involve (i) parsing through user preference data, driver history data, profile data (of the requesting user and/or the proximate drivers), the pick-up request (and the identified destination), and proximity and/or ETA data, (ii) weighing each respective optimization factor against identified user preferences, and (iii) generating an optimization score for each of the proximate drivers.

The optimization score for each proximate driver may be compared with a selection threshold. Alternatively, the dispatch system 100 may automatically select the highest rated driver to service the pick-up request. Once an optimal driver is selected, the dispatch system 100 may assign the optimal driver to service the pick-up request (395). In some examples, the dispatch system 100 can provide a confirmation feature to a user device of the requesting user, where the confirmation feature includes driver data of the selected proximate driver. In such examples, the dispatch system 100 can receive one of a confirmation or a rejection of the selected proximate driver from the user device, and in response to receiving the confirmation, assign the selected driver to service the pick-up request. If a rejection is received, the dispatch system 100 can perform one or more alternative actions, such as select a next best proximate driver, based on the matching operation, to assign to the pick-up request. Accordingly, for this driver/user pairing, the process can end (399).

The above processes discussed with respect to FIGS. 3A and 3B may be performed on a local, regional, national, or global scale. Cultural attributes in certain regions may differ from others that may affect the manner in which drivers and users are paired or the ratings thresholds that may be determinative in such pairings. For example, regional ratings data may indicate certain cultural traits in which local users rate drivers more or less harshly, and/or submit more or less complaints regarding certain driver characteristics. Regional data may further indicate alternative user preferences of which a centralized dispatch system (e.g., dispatch system 100) may take into account in weighing certain optimization factors and ultimately matching drivers and requesting users. As an example, Canadian users may show a propensity towards giving drivers a maximum rating regardless of the quality of the experience. In order to enhance the user experience of Canadian users, the dispatch system 100 may set default weightings to certain preferences that may be universally shared amongst all users. For example, the dispatch system 100 may, by default, weigh newer model vehicles over older model vehicles. As another example, the dispatch system 100 may weigh a proximate driver that has a home address within certain proximity of the destination over proximate drivers that are more likely to be unfamiliar with the nuances of traffic conditions surrounding the destination. In accordance with examples described herein, the dispatch system 100 may set universal defaults for certain factors during dynamic matching operations based on a region or based on a lack of data from the ratings history of users and drivers.

User Interface Examples

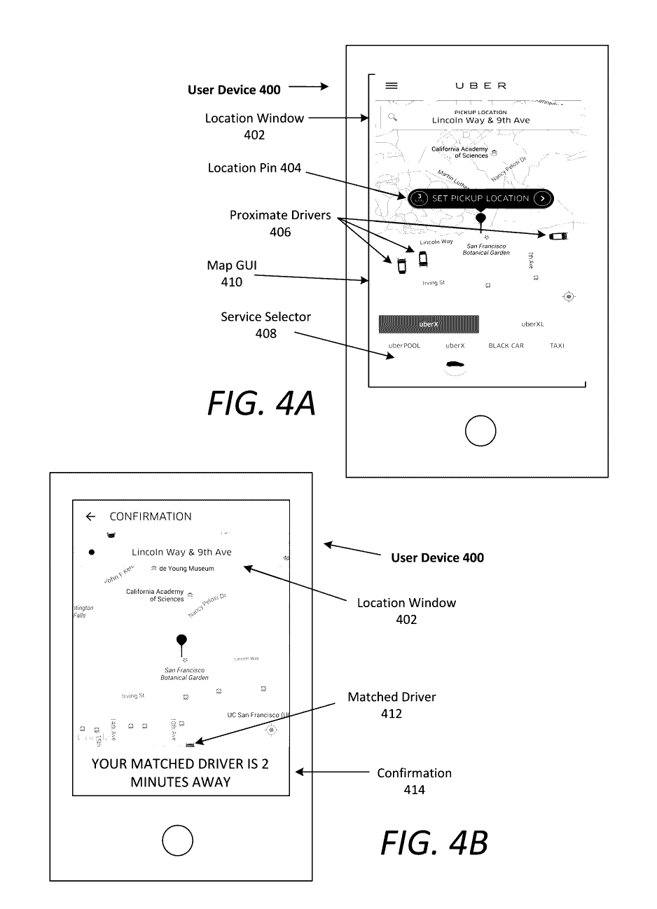

FIGS. 4A and 4B are example screenshots illustrating a user request and match confirmation on a user device. Referring to FIG. 4A, a requesting user may launch a designated application specific to a network service on the user's device 400. In response to launching the application, a GUI 410 can be generated on the device 400 showing a location window 402, which can be associated with a location pin 404 on the device. The location pin 404 can be shown, by default, close to or at the current location of the user. The location window 402 can enable the user to input an address or location for pick-up. Additionally or alternatively, the user can provide input on the map on the GUI 410 to move the location pin 404 to a given location to specify a pick-up location. Upon setting the location pin 404, the location window 402 can automatically display an address corresponding to the location pin 404. In the example provided, the user has placed the location pin 404 for pick-up at the San Francisco Botanical Gardens, which the application has identified as “Lincoln Way & 9th Ave” in the location window 402.

The GUI 410 can further include a service selector 408 which can enable the user to select a service type—which itself may be used as a weighted optimization factor for the dispatch system 100 in performing the matching operation. For example, “uberX” as shown in FIG. 4A can correspond to one service type, while “Black Car” can correspond to a different, second service type. Similarly, a secondary selection feature can enable the user to select either “uberX” or “uberXL,” in this example, which corresponds to a standard size vehicle or a larger size vehicle (SUV), respectively. In some instances, even if the user selects “uberX,” the network service can still select a larger SUV vehicle for the user, based on the optimized matching operation, such as described in FIGS. 1 through 3B. The GUI 410 may also display the relative locations of proximate drivers 406 to the requesting user's current location, or to the placement of the location pin 404, that corresponds to the currently selected service type (e.g., in this example, vehicles are shown that correspond to the “uberX” service type). For dynamic implementations, the GUI 410 may further identify a preliminary optimization score for each of the proximate drivers 406. The user may utilize a selection feature, for example, a selection feature on the location pin 404, to request a pick-up. The user may then set a destination location and submit the pick-up request.

Referring to FIG. 4B, in response to submitting the pick-up request, the dispatch system 100 can perform the matching operation as provided herein, and select a most optimal driver (i.e., the matched driver 412) from the proximate drivers 406 to provide the transport service for the user. The GUI 410 may be presented as a confirmation screen on the user device 400 that may present a confirmation 414 that the matched driver 412 is en route. In examples described herein, the selected driver may not necessarily be the closest driver by distance or ETA, but may be the driver that the dispatch system determines is the optimal driver based on that driver having the highest optimization score of the proximate drivers, e.g., having the highest probability that the user would give that driver a maximum satisfaction rating in view of the user information, the current conditions associated with the request (e.g., the pick-up location, the vehicle type, the destination location, etc.) and the determined behavior or characteristics of the proximate drivers.

Hardware Diagrams

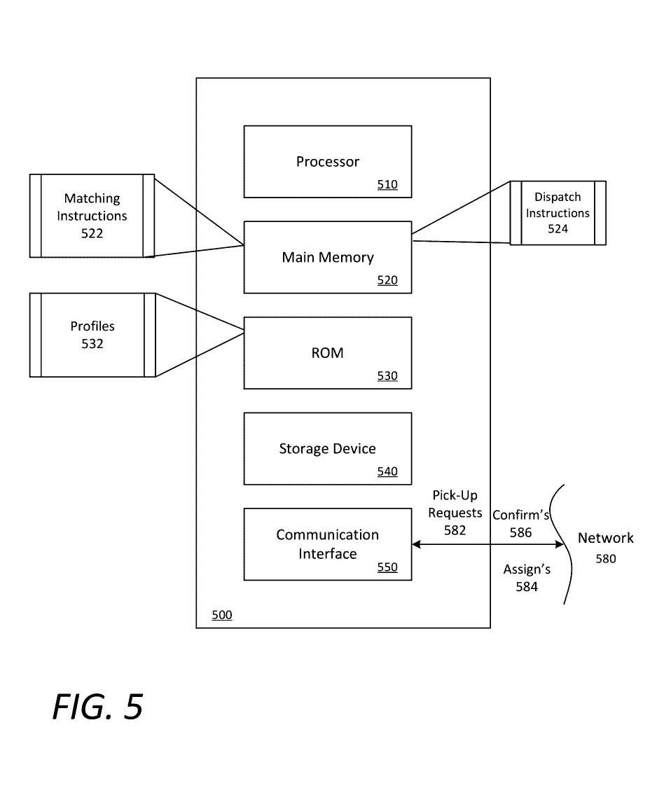

FIG. 5 is a block diagram that illustrates a computer system upon which examples described herein may be implemented. A computer system 500 can be implemented on, for example, a server or combination of servers. For example, the computer system 500 may be implemented as part of a network service for providing transportation services. In the context of FIG. 1, the dispatch system 100 may be implemented using a computer system such as described by FIG. 5. The dispatch system 100 may also be implemented using a combination of multiple computer systems as described in connection with FIG. 5.

In one implementation, the computer system 500 includes processing resources 510, a main memory 520, a read-only memory (ROM) 530, a storage device 540, and a communication interface 550. The computer system 500 includes at least one processor 510 for processing information stored in the main memory 520, such as provided by a random access memory (RAM) or other dynamic storage device, for storing information and instructions which are executable by the processor 510. The main memory 520 also may be used for storing temporary variables or other intermediate information during execution of instructions to be executed by the processor 510. The computer system 500 may also include the ROM 530 or other static storage device for storing static information and instructions for the processor 510. A storage device 540, such as a magnetic disk or optical disk, is provided for storing information and instructions.

The communication interface 550 enables the computer system 500 to communicate with one or more networks 580 (e.g., cellular network) through use of the network link (wireless or a wire). Using the network link, the computer system 500 can communicate with one or more computing devices, and one or more servers. In accordance with examples, the computer system 500 receives pick-up requests 582 from mobile computing devices of individual users. The executable instructions stored in the memory 530 can include matching instructions 522, which the processor 510 executes to match the requesting user with an optimal driver from a pool of proximate drivers. The executable instructions stored in the memory 520 can also include dispatch instructions 524, which enables the computer system 500 to receive pick-up requests 582 and transmit driver assignments 584 to selected drivers. The memory 530 can include profiles 532 for users and drivers of the transport service. By way of example, the instructions and data stored in the memory 520 can be executed by the processor 510 to implement an example dispatch system 100 of FIG. 1. In performing the operations, the processor 510 can generate and send assignments 582 and confirmations 586 via the communication interface 550 to the mobile computing devices of the drivers and users respectively.

The processor 510 is configured with software and/or other logic to perform one or more processes, steps and other functions described with implementations, such as described by FIGS. 1 through 4B, and elsewhere in the present application.

Examples described herein are related to the use of the computer system 500 for implementing the techniques described herein. According to one example, those techniques are performed by the computer system 500 in response to the processor 510 executing one or more sequences of one or more instructions contained in the main memory 520. Such instructions may be read into the main memory 520 from another machine-readable medium, such as the storage device 540. Execution of the sequences of instructions contained in the main memory 520 causes the processor 510 to perform the process steps described herein. In alternative implementations, hard-wired circuitry may be used in place of or in combination with software instructions to implement examples described herein. Thus, the examples described are not limited to any specific combination of hardware circuitry and software.

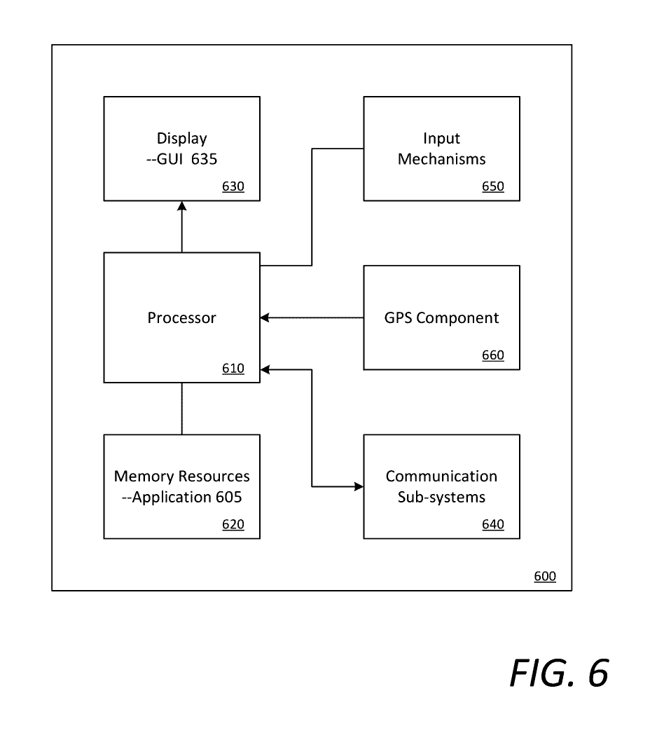

FIG. 6 is a block diagram that illustrates a mobile computing device upon which examples described herein may be implemented. In one example, a mobile computing device 600 may correspond to, for example, a cellular communication device (e.g., feature phone, smartphone etc.) that is capable of telephony, messaging, and/or data services. In variations, the mobile computing device 600 can correspond to, for example, a tablet or wearable computing device. Still further, the mobile computing device 600 can be distributed amongst multiple portable devices of drivers, and requesting users.

In an example of FIG. 6, the computing device 600 includes a processor 610, memory resources 620, a display device 630 (e.g., such as a touch-sensitive display device), one or more communication sub-systems 640 (including wireless communication sub-systems), input mechanisms 650 (e.g., an input mechanism can include or be part of the touch-sensitive display device), and one or more location detection mechanisms (e.g., GPS component) 660. In one example, at least one of the communication sub-systems 640 sends and receives cellular data over data channels and voice channels.

A driver of a transport vehicle can operate the mobile computing device 600 when on a shift to provide transportation services. The memory resources 620 can store one or more applications 605 for linking the mobile computing device 600 with a network service that enables or otherwise facilitates the drivers' ability to efficiently service pick-up requests. Execution of the application 605 by the processor 610 may cause a specified graphical user interface (GUI) 635 to be generated on the display 630. Interaction with a driver GUI 635 can enable drivers of transport vehicles to receive assignments to service pick-up requests or perform a pickup and/or drop-off. Further still, interaction with a requestor GUI can enable requesting users to request a pick-up for transportation service to a selected destination.

While examples of FIG. 5 and FIG. 6 provide for a computer system 500 and mobile computing device 600 for implementing aspects described, in some variations, the mobile computing device 600 can operate to implement some or all of the functionality described with the dispatch system 100.

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude claiming rights to such combinations.

What is claimed is:

1. A dispatch system comprising:
one or more processors; and
one or more memory resources storing instructions that, when executed by the one or more processors, cause the dispatch system to:
receive, from a user device over one or more networks, a pick-up request from a requesting user, the pick-up request specifying a pick-up location;
identify a plurality of proximate drivers based on the pick-up request location;
compute an optimization score for each respective one of the plurality of proximate drivers, the optimization score corresponding to a probability that the requesting user will provide the respective proximate driver with a maximum satisfaction rating; and
select one of the plurality of proximate drivers to service the pick-up request based on the computed optimization scores for the plurality of proximate drivers.

2. The dispatch system of claim 1, wherein the executed instructions further cause the dispatch system to:
store historical user data for the requesting user, historical user data including information from previous transport services received by the requesting user.

3. The dispatch system of claim 2, wherein the executed instructions cause the dispatch system to:
analyze the historical user data to determine a number of user preferences.

4. The dispatch system of claim 3, wherein the executed instructions further cause the dispatch system to:
store historical driver data for each of the plurality of proximate drivers;
compare the historical user data against the historical driver data for each of the plurality of proximate drivers; and
identify a plurality of relevant factors to compute the optimization score based on comparing the historical user data against the historical driver data.

5. The dispatch system of claim 4, wherein the executed instructions cause the dispatch system to compare the historical user data against the historical driver data by (i) for each of the plurality of proximate drivers, identifying a number of the plurality of relevant factors in the historical driver data based on the determined user preferences, and (ii) for each of the plurality of proximate drivers, applying a weighting to each of the identified relevant factors based on a corresponding user preference from the determined user preferences.

6. The dispatch system of claim 5, wherein the identified relevant factors comprise complaint data indicating a number of user complaints against the proximate driver.

7. The dispatch system of claim 5, wherein the identified relevant factors comprise reputation information for each of the plurality of proximate drivers.

8. The dispatch system of claim 4, wherein the historical user data comprise individual user ratings of respective drivers, each of the individual user ratings being specific to a respective user destination.

9. The dispatch system of claim 8, wherein the historical driver data comprise individual driver ratings for each of the plurality of proximate drivers, each of the individual driver ratings being specific to a respective user and a respective driver destination.

10. The dispatch system of claim 9, wherein the executed instructions cause the dispatch system to compute the optimization score for each of the plurality of drivers based on comparing the individual user ratings from the historical user data with the individual driver ratings for the plurality of proximate drivers.

11. The dispatch system of claim 9, wherein the executed instructions further cause the dispatch system to:
identify a destination associated with the pick-up request; and
identify, from the individual driver ratings for each of the plurality of proximate drivers, one or more of the individual driver ratings that match the destination;
wherein computing the optimization score further comprises applying a weighting to each of the one or more individual driver ratings that match the destination.

12. The dispatch system of claim 11, wherein the executed instructions further cause the dispatch system to:
identify a specified proximate driver having a highest individual driver rating that matches the destination;
wherein the dispatch system is to apply a maximum weighting to the highest individual driver rating for the specified proximate driver.

13. The dispatch system of claim 4, wherein the historical driver data comprise driver characteristics for each of the plurality of proximate drivers.

14. The dispatch system of claim 13, wherein the executed instructions cause the dispatch system compute the optimization score by comparing the determined user preferences of the requesting user with the driver characteristics of each of the plurality of proximate drivers.

15. The dispatch system of claim 14, wherein the determined user preferences indicate a preferred type of car, and wherein the driver characteristics for each of the plurality of proximate drivers indicate a type of car.

16. The dispatch system of claim 1, wherein the executed instructions further cause the dispatch system to:
provide a confirmation feature to the user device of the requesting user, the confirmation feature comprising driver data of the selected proximate driver; and
receive one of a confirmation or a rejection of the selected proximate driver from the user device.

17. The dispatch system of claim 16, wherein the executed instructions further cause the dispatch system to:
in response to receiving the confirmation, provide an invitation to the selected driver to service the pick-up request.

18. The dispatch system of claim 16, wherein the executed instructions further cause the dispatch system to:
in response to receiving the rejection, select a second one of the plurality of proximate drivers based on computing the optimization score.

19. A method for matching drivers with requesting users in connection with a transport service, the method performed by one or more processors of a dispatch system and comprising:
receiving, from a user device over one or more networks, a pick-up request from a requesting user, the pick-up request specifying a pick-up location;
identifying a plurality of proximate drivers based on the pick-up request location;
computing an optimization score for each respective one of the plurality of proximate drivers, the optimization score corresponding to a probability that the requesting user will provide the respective proximate driver with a maximum satisfaction rating; and
selecting one of the plurality of proximate drivers to service the pick-up request based on the computed optimization scores for the plurality of proximate drivers.

20. A non-transitory computer-readable medium storing instructions that, when executed by one or more processors of a dispatch system, cause the dispatch system to:
receive, from a user device over one or more networks, a pick-up request from a requesting user, the pick-up request specifying a pick-up location;
identify a plurality of proximate drivers based on the pick-up request location;
compute an optimization score for each respective one of the plurality of proximate drivers, the optimization score corresponding to a probability that the requesting user will provide the respective proximate driver with a maximum satisfaction rating; and
select one of the plurality of proximate drivers to service the pick-up request based on the computed optimization scores for the plurality of proximate drivers.
